(19) United States
(12) Patent Application Publication
(10) Pub. No.: US 2026/0321951 A1
(43) Pub. Date: Oct. 15, 2026

(54) COUPLER

(71) Applicant: STMicroelectronics International N.V., Geneva (CH)

(72) Inventors: Ophelie FOISSEY, La Terrasse (FR); Vincent KNOPIK, Crets en Belledonne (FR)

(73) Assignee: STMicroelectronics International N.V., Geneva (CH)

(21) Appl. No.: 19/636,505

(22) Filed: Apr. 1, 2026

(30) Foreign Application Priority Data
Apr. 11, 2025 (FR) FR2503896

(51) Int. Cl. H01P 5/12

(52) U.S. Cl. CPC H01P 5/12

(57) ABSTRACT

The present description concerns a coupler including a first input terminal coupled to a first output terminal by a first metallization; and a second input terminal coupled to a second output terminal by a second metallization. Each of the first and second metallization is divided into a first portion arranged in a first metallization level located in a first plane, and a second portion arranged in a second metallization level located in a second plane, different from the first plane and parallel to the first plane. Each of the first portions of metallization is positioned directly above one of the second portions of metallization.

### CROSS-REFERENCE TO RELATED APPLICATION(S)

This application claims the priority benefit of French patent application number FR 2503896, filed on Apr. 11, 2025, entitled “Coupleur”, which is hereby incorporated by reference to the maximum extent allowable by law.

### BACKGROUND

### Technical Field

The present disclosure generally concerns electronic circuits and devices adapted to using signals, and in particular radio frequency signals. The present disclosure concerns a hybrid coupler, and more particularly a ninety-degree hybrid coupler.

### Description of the Related Art

Couplers are electronic devices used to couple a plurality of electronic signals, and for example signals used in the radio frequency field, that is, signals having frequencies in the range from a few hertz to more than 300 kHz, for example from 3 kHz to 300 GHz.

It would be desirable to be able to improve, at least partly, certain aspects of couplers, and in particular of hybrid couplers.

### BRIEF SUMMARY

There exists a need for higher-performance couplers.

There exists a need for couplers having a smaller bulk.

An embodiment overcomes all or part of the disadvantages of known couplers.

An embodiment provides a coupler having a smaller bulk.

An embodiment provides a coupler having less signal loss.

An embodiment overcomes all or part of the disadvantages of known couplers.

An embodiment overcomes all or part of the disadvantages of known signal coupling methods.

An embodiment provides a coupler comprising:
a first input terminal coupled to a first output terminal by a first metallization; and
a second input terminal coupled to a second output terminal by a second metallization,
wherein each first and second metallization is divided into a first portion arranged in a first metallization level located in a first plane, and a second portion arranged in a second metallization level located in a second plane, different from the first plane and parallel to the first plane,
wherein each of the first portions of metallization is positioned directly above one of the second portions of metallization.

Another embodiment provides a method of coupling two signals using a coupler comprising:
a first input terminal coupled to a first output terminal by a first metallization; and
a second input terminal coupled to a second output terminal by a second metallization,
wherein each first and second metallization is divided into a first portion arranged in a first metallization level located in a first plane, and a second portion arranged in a second metallization level located in a second plane, different from the first plane and parallel to the first plane,
wherein each of the first portions of metallization is positioned directly above one of the second portions of metallization.

According to an embodiment, the first portion of the first metallization is arranged directly above the second portion of the second metallization.

According to an embodiment, a first current flowing through the first portion of the first metallization flows in a direction opposite to that of a second current flowing through the second portion of the second metallization.

According to an embodiment, the first portion of the first metallization is arranged directly above the second portion of the first metallization.

According to an embodiment, a first current flowing through the first portion of the first metallization flows in a direction identical to that of a second current flowing through the second portion of the first metallization.

According to an embodiment, the first portion of the first metallization and the second portion of the first metallization are coupled together by a first conductive via.

According to an embodiment, the first portion of the second metallization and the second portion of the second metallization are coupled together by a second conductive via.

According to an embodiment, said first metallization is generally spiral-shaped,
said second metallization is generally spiral-shaped.

According to an embodiment, said first metallization is in the general shape of a spiral comprising at least half a turn,
said second metallization is in the general shape of a spiral comprising at least half a turn.

According to an embodiment, said first metallization is in the general shape of a spiral inscribed within a rectangular, square, rounded, or elliptical shape,
said second metallization is in the general shape of a spiral inscribed within a rectangular, square, rounded, or elliptical shape.

According to an embodiment, the first and second metallizations are arranged so as to leave a gap between their first and second portions.

According to an embodiment, the coupler is a ninety-degree hybrid coupler.

According to an embodiment, the coupler is a one-hundred-and-eighty-degree hybrid coupler.

Another embodiment provides an electronic device comprising at least two couplers described hereabove coupled in series with one another.

According to an embodiment, said at least two couplers are positioned in a same third plane.

According to an embodiment, said at least two couplers are positioned one above the other in fourth planes parallel to one another.

### BRIEF DESCRIPTION OF THE SEVERAL VIEWS OF THE DRAWINGS

The foregoing features and advantages, as well as others, will be described in detail in the rest of the disclosure of specific embodiments given as an illustration and not limitation with reference to the accompanying drawings, in which:

FIG. 1A shows an electrical symbol of an embodiment of a hybrid coupler;

FIG. 1B shows an equivalent circuit diagram of the embodiment of the hybrid coupler of FIG. 1A;

FIG. 2 shows in top view a unit element forming a coupler according to the embodiment of FIG. 1;

FIG. 3 shows three diagrams illustrating an embodiment of a coupler;

FIGS. 4A, 4B, 4C, and 4D show four views of an embodiment of a coupler;

FIG. 5 shows in more detail a side view of a coupling formed between two levels of the coupler of FIGS. 4A, 4B, 4C, and 4D;

FIG. 6 shows a perspective view of an embodiment of a coupler;

FIG. 7 shows an equivalent circuit diagram of the embodiment of the coupler of FIG. 6;

FIGS. 8A and 8B show two views of the embodiment of FIG. 6;

FIGS. 9A, 9B, and 9C show three graphs illustrating the performance of the embodiment of FIG. 6;

FIG. 10 shows a perspective view of another embodiment of a coupler;

FIG. 11 shows a perspective view of another embodiment of a coupler;

FIGS. 12A, 12B, and 12C show three graphs illustrating the performance of the embodiment of FIG. 11; and

FIG. 13 shows a perspective view of another embodiment of a coupler.

### DETAILED DESCRIPTION

The same elements have been designated by the same references in the various figures. In particular, structural and/or functional elements common to the different embodiments may have the same references and may have identical structural, dimensional and material properties.

For the sake of clarity, steps and elements that are useful for understanding the described embodiments have been shown and have been described in detail.

Unless otherwise specified, when reference is made to two elements being connected to each other, this means directly connected without any intermediate elements other than conductors, and when reference is made to two elements being coupled to each other, this means that these two elements may be connected or may be connected via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

The embodiments described hereafter concern the forming of a ninety-degree hybrid coupler, that is, a coupler adapted to shifting the phase of a signal by ninety degrees. These embodiments concern, in particular, a coupler having a more compact structure formed by at least two metallization levels, the shape of which can be adapted at will.

Further, the embodiments described hereafter are particularly adapted to being used in any type of industrial market where radio frequency signals are used. More particularly, such a radio frequency signal amplifier may be intended for:
the automotive industry, for example in the field of automotive electrification or in the field of advanced driver assistance systems (ADAS);
the industrial sector, for example in the field of green energy, in the field of infrastructure electrification, of the Internet of Things (IoT) and smart homes, where electricity and energy consumption and data exchange are key elements;
the personal electronics industry, for example in the field of mobile telephony and the Internet of Things (IoT), as well as in the field of broadband interfaces; and
the industry of communications equipment, computers, and peripherals, for example in the field of infrastructure and data centers, and in the field of low earth orbit (LEO) satellites.

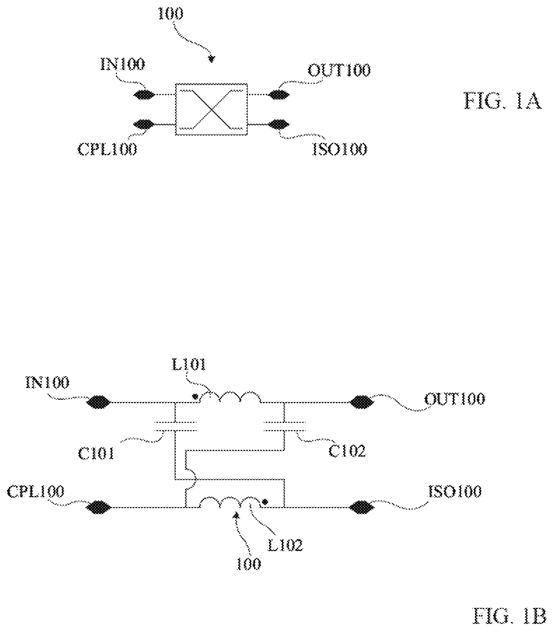

FIGS. 1A and 1B show diagrams of a coupler 100. FIG. 1A shows the electrical symbol of coupler 100, and FIG. 1B shows an equivalent electrical diagram of coupler 100.

According to an example, coupler 100 is a hybrid coupler. According to a preferred example, coupler 100 is a ninety-degree hybrid coupler, but could be a one-hundred-and-eighty-degree hybrid coupler. For this purpose, coupler 100 comprises:
a first input IN100 adapted to receiving a first signal;
a second input CPL100 adapted to receiving a second signal;
a first output OUT100 adapted to delivering a third signal; and
a second output ISO100 adapted to delivering a fourth signal.

According to an example, the second signal is equal to the first signal, phase-shifted. According to the preferred example, the second signal is equal to the first signal phase-shifted by ninety degrees. According to another example within accessible to those skilled in the art, the second signal may be equal to the first signal phase-shifted by one hundred and eighty degrees.

When coupler 100 is a ninety-degree hybrid coupler, the third signal, delivered by output OUT100, corresponds to the sum of the signals received at its input, and the fourth signal is a zero signal.

According to an example, coupler 100 is reversible, and, by inverting the inputs and outputs, may be a signal splitter circuit.

Coupler 100 comprises, according to the behavioral pattern, two coils L101 and L102 and two capacitors C101 and C102.

In FIGS. 1A and 1B, the input terminal of a coil is represented by a phase point (shown by a point in view (B)), and the output terminal is left with no phase point. This means that the current flowing through the coil flows therethrough from the input terminal to the output terminal, depending on the selected representation.

According to an example, an input node of coil L101 is coupled, preferably connected, to input IN100 of coupler 100, and an output node of coil L101 is coupled, preferably connected, to output OUT100 of coupler 100. An input node of coil L102 is coupled, preferably connected, to output ISO100 of coupler 100, and an output node of coil L102 is coupled, preferably connected, to output OUT100 of coupler 100.

According to an example, a first node of capacitor C101 is coupled, preferably connected, to input IN100 of coupler 100, and a second node of capacitor C101 is coupled, preferably connected, to output ISO100 of coupler 100. According to an example, a first node of capacitor C102 is coupled, preferably connected, to input CPL100 of coupler 100, and a second capacitor node C102 is coupled, preferably connected, to output OUT100 of coupler 100.

A physical implementation of coupler 100 is described in relation with FIG. 2.

FIG. 2 is a top view of a physical implementation of the coupler 100 described in relation with FIGS. 1A and 1B. More particularly, FIG. 2 is a top view of a unit element 100 enabling to form coupler 100.

Unit element 100 comprises two coils 201 and 202 arranged in the form of a cross or of an “x”. More particularly, the first coil 201 forms a first arm of the cross or “x”, and the second coil 202 forms a second arm of the cross or “x”. According to an example, these coils 201 and 202 are formed from one or more metallizations.

More specifically, the two coils 201 are arranged in the form of a cross having a general “H” shape. In other words, all the arms of the cross formed by coils 201 and 202 follow a same direction, and are thus parallel to one another. Thus, one here calls cross having a general “H” shape the shape taken by the coils 201 and 202 shown in FIG. 2.

Unit element 200 comprises two input terminals and two output terminals similar to the inputs and outputs of coupler 100. More particularly, unit element 200 comprises:
a first input terminal IN200 corresponding to an input node of coil 201;
a second input terminal CPL200 corresponding to an input node of coil 202;
a first output terminal OUT200 corresponding to an output node of coil 201; and
a second output terminal ISO200 corresponding to an output node of coil 202.

The capacitors of the coupler are de facto formed between the arms of the cross of coils 201 and 202. More particularly, the capacitors represent the intrinsic capacitances of the arms of the cross formed by the coils. As a variant, capacitors may be added to the structure shown in FIG. 2. In addition, and according to an embodiment, coils 201 and 202 are strongly coupled to each other, for example with a coupling coefficient greater than 0.5, preferably greater than 0.8.

More particularly, the first and second input terminals IN200 and CPL200 are both arranged on a same arm of the general “H” shape of the cross of unit element 200. Similarly, the first and second output terminals OUT200 and ISO200 are both arranged on the other arm of the general “H” shape of the cross of unit element 200. In other words, the first and second input terminals IN200 and CPL200 are arranged on the same side (left-hand side in FIGS. 1A and 1B) on a first long side of the unit element, the first and second output terminals OUT200 and ISO200 are arranged on the same side (right-hand side in FIGS. 1A and 1B) on the other long side of unit element 200. Still in other words, the first and second input terminals IN200 and CPL200 are not arranged on different arms of the general “H” shape of the cross of unit element 200. Similarly, the first and second output terminals OUT200 and ISO200 are not arranged on different arms of the general “H” shape of the cross of unit element 200.

The dimensions of unit element 200 enable to define the electrical characteristics of the coupler, such as the inductances of coils 201 and 202 and the capacitances of the capacitors. The dimensions of unit element 200 should thus be adapted to adjust the functionalities of the coupler that it forms.

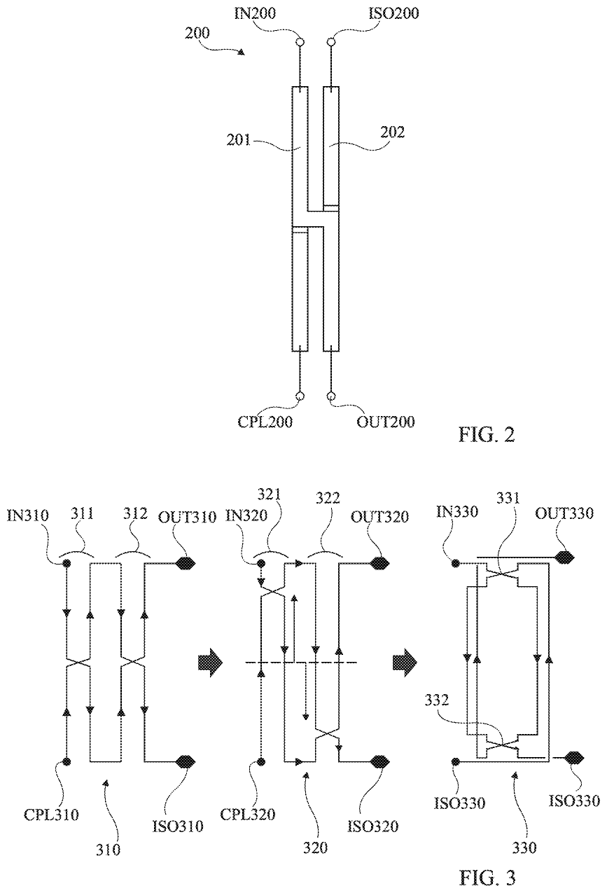

One unit element 200 is used to form a coupler of the type of coupler 100, but it is also possible to assemble a plurality of unit elements 200 to obtain a coupler of the type of coupler 100. An advantage of assembling a plurality of unit elements 200 is that this enables to limit the bulk of a coupler 100 while enabling it to be given different shapes. Examples of assemblies of unit elements 200 are described hereafter in relation with FIGS. 3 to 13.

FIG. 3 shows, very schematically, three examples of assembly 310, 320, and 330 of two unit elements of the type of the unit element 200 described in relation with FIG. 2. It is said that in assemblies 310, 320, and 330, the unit elements are coupled in series.

In FIG. 3, each unit element is very schematically represented by their general shape represented in wire form. In addition, the currents of the signals applied to the input terminals of the unit elements, and their directions, are represented by arrows.

Assembly 310 forms a coupler of the type of the coupler 100 described in relation with FIGS. 1A and 1B, and thus comprises two inputs IN310 and CPL310, and two outputs OUT310 and ISO310.

Assembly 310 comprises two generally “H” shaped unit elements, including:
an input unit element 311;
an output unit element 312.

Input unit element 311 is characterized in that its input terminals are coupled to the inputs of the assembly. More particularly, a first input terminal of element 311 is coupled, preferably connected, to input IN310 of the assembly, and a second input terminal of the element 311 is coupled, preferably connected, to input CPL310 of the assembly.

Output unit element 312 is characterized in that its output terminals are coupled to the outputs of assembly 310. More particularly, a first output terminal of element 312 is coupled, preferably connected, to output OUT310 of assembly 310, and a second output terminal of element 312 is coupled, preferably connected, to output ISO310 of assembly 310.

In addition, the output terminals of input unit element 311 are coupled to the input terminals of output unit element 312. More particularly, a first output terminal of input unit element 311, corresponding to terminal OUT200 of element 200, is coupled, preferably connected, to a first input terminal of output unit element 312, corresponding to terminal IN200 of element 200. A second output terminal of input unit element 311, corresponding to terminal ISO200 of the element 200, is coupled, preferably connected, to a first input terminal of output unit element 312, corresponding to terminal CPL200 of element 200.

In assembly 310, unit elements 301 and 302 are simply arranged side by side while respecting distances enabling to favor the torques required for the implementation of the coupling function of the coupler, and this, without modifying the general shape of unit elements 301 and 302.

Assembly 320 forms a coupler of the type of the coupler 100 described in relation with FIGS. 1A and 1B, and thus comprises two inputs IN320 and CPL320, and two outputs OUT320 and ISO320.

Assembly 320 comprises two unit elements including:
an input unit element 321;
an output unit element 322.

The input unit element 321 and the output unit element 322 of assembly 320 are coupled in the same way as the input unit element 311 and the output unit element 312 of assembly 310. Assembly 320 differs from element 310 in that the shapes of unit elements 321 and 322 have been modified. Indeed, the crossings of the coils forming the input and output unit elements 321 and 322 are shifted so as to make the general shape of unit elements 321 and 322 asymmetrical with respect to a horizontal axis shown in dotted lines in FIG. 3. According to an example, the crossing of the coils of input unit element 321 is shifted towards the “top” in FIG. 3, and the crossing of the coils of output unit element 322 is shifted towards the “bottom” in FIG. 3.

Assembly 320 forms a coupler of the type of the coupler 100 described in relation with FIGS. 1A and 1B, and thus comprises two inputs IN320 and CPL320, and two outputs OUT320 and ISO320.

Assembly 330 comprises two unit elements including:
an input unit element 331;
an output unit element 332.

The input and output unit elements 331 and 332 of assembly 330 are coupled in the same way as the input and output unit elements 311 and 312 of assembly 310. Assembly 330 differs from assembly 310 in that the shapes of unit elements 331 and 332 have been modified in the same way as those of the unit elements 321 and 322 of assembly 320.

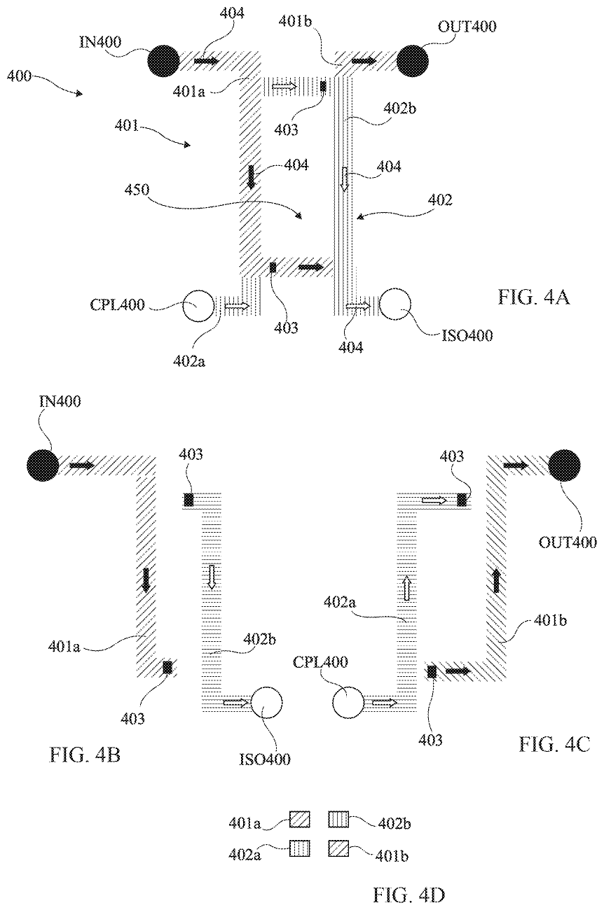

In addition, and according to an embodiment, input unit elements 331 and 332 are not arranged side by side in the same plane as in assemblies 310 and 320, but are arranged one on top of the other, so that their longer arms overlap. This enables to create an additional coupling. A detailed example of an assembly 320, called coupler hereafter, is described in relation with FIGS. 4A, 4B, 4C, and 4D.

Assemblies 320 and 330 have the advantage of improving the coupling between the two unit elements, as compared with assembly 310. Further, assembly 330 has the advantage of adding an additional coupling to assemblies 310 and 320. This additional coupling is detailed in relation with FIGS. 4A, 4B, 4C, and 4D.

FIGS. 4A, 4B, 4C, and 4D comprises four views of an embodiment of a coupler 400 of the type of the assembly 330 described in relation with FIG. 3.

FIG. 4A is a top view of coupler 400. FIG. 4B is a partial view of coupler 400 corresponding to a top view of an upper level of metallization of coupler 400. FIG. 4C is a partial view of coupler 400 corresponding to a top view of a lower level of metallization of coupler 400. FIG. 4D is a cross-section view of coupler 400, which is not to scale.

Coupler 400 is formed, in practice, by two metallizations 401 and 402, or conductive tracks 401 and 402, forming the coils of the unit elements forming coupler 400. These metallizations 401 and 402 are each arranged astride a first metallization level, or upper level, and on a second metallization level, or lower level. The first metallization level is arranged in a first plane, and the second metallization level is arranged in a second plane different from and parallel to the first plane. For example, in FIGS. 4A, 4B, 4C, and 4D, the first metallization level is arranged above the second metallization level. The locations where the metallizations change metallization level are indicated in FIG. 4, and in particular in the views in FIGS. 4A, 4B, and 4C, by black rectangles 403.

According to an embodiment, each metallization 401, 402 is divided into a portion 401a, 402b arranged in the first metallization level, and a portion 401b, 402a arranged in the second metallization level. In addition, and still according to an embodiment, each of the portions 401a, 402b of the metallizations arranged in the first metallization level is positioned directly above one of the metallization portions 401b, 402a arranged in the second metallization level.

Further, according to an embodiment, when a metallization portion located in the first level is arranged directly above another portion of this same metallization, then it is important to circulate in these metallization portions currents flowing in the same direction. Conversely, when a metallization portion located in the first level is arranged directly above a portion of another metallization, then it is important to circulate in these metallization portions currents flowing in opposite directions.

In the example of FIGS. 4A, 4B, 4C, and 4D, it is considered that the first portion 401a of metallization 401 is arranged in the first metallization level, and that a second portion 401b of metallization 401 is arranged in the second metallization level. In the example of FIGS. 4A, 4B, 4C, and 4D, the first portion 401 a is further coupled, preferably connected, to a first input terminal IN400 of the coupler 400, and the second portion 401b is further coupled, preferably connected, to a first output terminal OUT400 of coupler 400. Similarly, in the example of FIGS. 4A, 4B, 4C, and 4D, it is considered that the first portion 402 a of metallization 402 is arranged in the second metallization level, and that a second portion 402b of metallization 402 is arranged in the first metallization level. In the example of FIGS. 4A, 4B, 4C, and 4D, the first portion 402a is further coupled, preferably connected, to a first input terminal CPL400 of coupler 400, and the second portion 402b is further coupled, preferably connected, to a first output terminal ISO400 of coupler 400. In the example of FIGS. 4A, 4B, 4C, and 4D, portion 401a of metallization 401 is arranged directly above portion 402a of metallization 402, and portion 402b of metallization 402 is arranged directly above portion 401b of metallization 401.

According to an embodiment, the two portions 401a and 401b, or 402a and 402b, of the same metallization may be directly connected to each other by continuity of the metallization. According to another embodiment, the two portions 401a and 401b, or 402a and 402b, of a same metallization may be coupled together by a connector such as, for example, an electrically-conductive via.

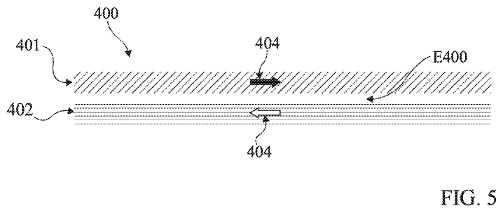

FIG. 4 A, 4B, 4C, and 4D also show the direction of the signals applied to the input terminals of coupler 400 by arrows 404. According to an embodiment, portion 401a is arranged directly above portion 402a, so as to create an additional coupling within the coupler. Similarly, according to an embodiment, portion 401b is arranged directly under portion 402b, so as to create another additional coupling within the coupler. Indeed, it can be observed, due to arrows 404, that the directions of the signals flowing through the metallization portions are always reversed, which creates a coupling. This additional coupling is described in greater detail in relation with FIG. 5.

Further, the space 450 available in the middle of coupler 400 can be advantageously used to arrange therein one or more electronic components, such as resistors, capacitors or transistors. Indeed, this space is submitted to magnetic fields of opposite directions, which cancel each other out.

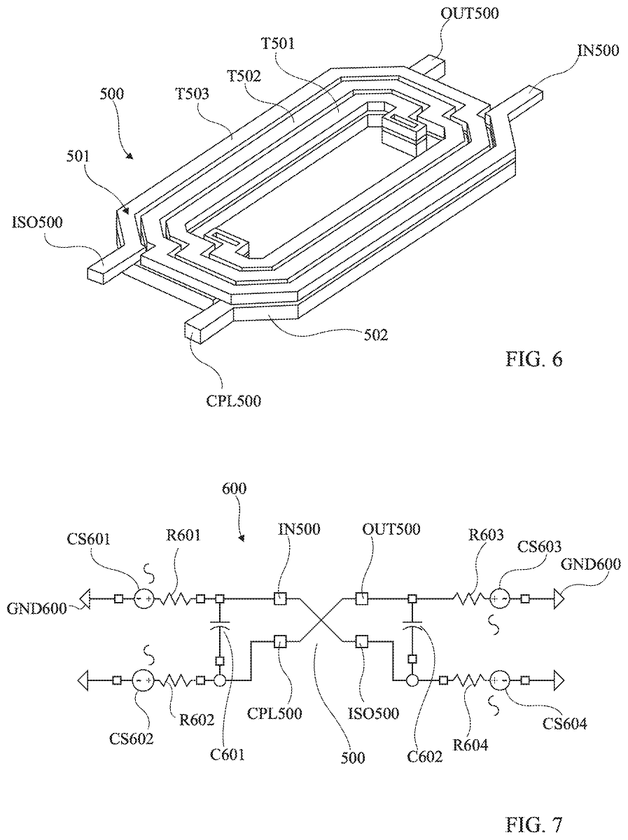

The shape of the coupler 400 shown in FIGS. 4A, 4B, 4C, and 4D is the simplest shape that it can take. Variants of coupler 400, and their performance, are detailed in relation with FIGS. 6 to 13.

Also concerned by the present description are signal coupling methods using a coupler of the type of the coupler 400 described herein.

FIG. 5 is a side view of a portion of the coupler 400 described in relation with FIGS. 4A, 4B, 4C, and 4D illustrating the additional coupling added by the specific arrangement of metallizations 401 and 402 described in relation with FIGS. 4A, 4B, 4C, and 4D.

More particularly, FIG. 5 is a side view illustrating the case where two portions of metallization 401 and 402 are arranged in two different metallization levels and directly one above the other. In the case where two portions of metallization 401 or of metallization 402 are arranged directly one above the other, the currents flowing therethrough have an identical direction.

It should be noted that the currents flowing through these two metallization portions, having their direction represented by arrows 404, have opposite directions. This creates a coupling which is not present in the other assemblies 310 and 320 described in relation with FIG. 3. The gap E400 between the two metallization levels enables to adjust the strength of this coupling.

FIG. 6 is a perspective view of an embodiment of a coupler 500 being a variant of the coupler 400 of FIGS. 4A, 4B, 4C, and 4D.

According to a preferred example, metallizations 401 and 402 are arranged symmetrically with respect to a central axis parallel to the longest length of the metallizations 401, 402, corresponding to a vertical axis in FIG. 4A, and have similar, preferably equal, lengths. Having metallizations 401 and 402 arranged asymmetrically and/or having very different lengths could reduce the performance of coupler 400.

Coupler 500 is a coupler of the type of the assembly 330 described in relation with FIG. 3, and of the coupler 400 described in relation with FIGS. 4A, 4B, 4C, and 4D.

Coupler 500 is similar to coupler 400. The elements common to devices 400 and 500 are not described again in detail hereafter. The differences between couplers 400 and 500 are highlighted.

More particularly, like coupler 400, coupler 500 comprises two input terminals IN500 and CPL500 and two output terminals OUT500 and ISO500. In addition, like coupler 400, coupler 500 is formed from two metallization levels 501 and 502.

The difference between couplers 400 and 500 is that the metallizations of coupler 500 are arranged in spirals and comprise at least three turns. In addition, the shape of coupler 500 is substantially that of a rectangle with rounded corners, or is inscribed within a rectangular shape. By varying the number of turns of the metallizations of coupler 500, it is possible to vary the working frequency of coupler 500 by varying the dimensions of the coupler. Examples of couplers comprising different numbers of turns are described hereafter.

More specifically, in the example of FIG. 6, the metallizations of coupler 500 are arranged in spirals and comprise three turns T501, T502, and T503. The spacing between these turns is not submitted to a minimum distance.

According to an example, the spacing between the different metallization turns may not be uniform, but according to a preferred embodiment, the spacing between the different metallization turns is uniform.

Furthermore, it should be noted that the input and output terminals IN400, CPL400, OUT400, and ISO400 are arranged outside of the metallizations 401 and 402 in order to facilitate connections between the coupler 400 and other electronic components. If these input and output terminals were located in space 450, connecting coupler 400 to other components would require the addition of conductive tracks crossing or intersecting metallizations 401 and 402, which would create parasitic couplings that could disrupt the operation of the coupler and thus reduce its performance.

FIG. 7 is an electrical diagram 600 of the use in simulation mode of the coupler 500 described in relation with FIG. 6.

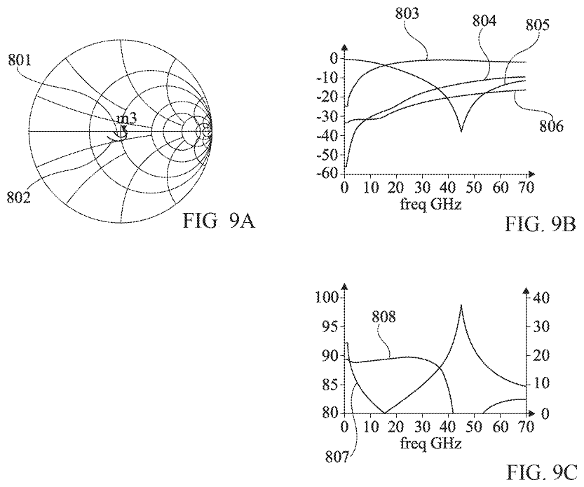

More particularly, electrical diagram 600 enables to simulate the performance of coupler 500 by using sources placed at the four terminals of coupler 500. The results are shown in FIGS. 9A, 9B, and 9C.

Electrical diagram 600 comprises coupler 500 and:
its input terminal IN500;
its input terminal CPL500;
its output terminal OUT500; and
its output terminal ISO500.

According to an example, diagram 600 further comprises two capacitors C601 and C602. A first terminal of capacitor C601 is coupled, preferably connected, to terminal IN500, and a second terminal of capacitor C601 is coupled, preferably connected, to terminal CPL500. A first terminal of capacitor C602 is coupled, preferably connected, to terminal OUT500, and a second terminal of capacitor C602 is coupled, preferably connected, to terminal ISO500.

According to an example, diagram 600 further comprises four resistors R601, R602, R603, and R604. A first terminal of resistor R601 is coupled, preferably connected, to terminal IN500, and a second terminal of resistor R601 is coupled, preferably connected, to a terminal GND600 adapted to receiving a reference voltage, for example, ground. A first terminal of resistor R602 is coupled, preferably connected, to terminal CPL500, and a second terminal of resistor R602 is coupled, preferably connected, to terminal GND600. A first terminal of resistor R603 is coupled, preferably connected, to terminal OUT500, and a second terminal of resistor R603 is coupled, preferably connected, to terminal GND600. A first terminal of resistor R604 is coupled, preferably connected, to terminal ISO500, and a second terminal of resistor R604 is connected, preferably connected, to terminal GND600.

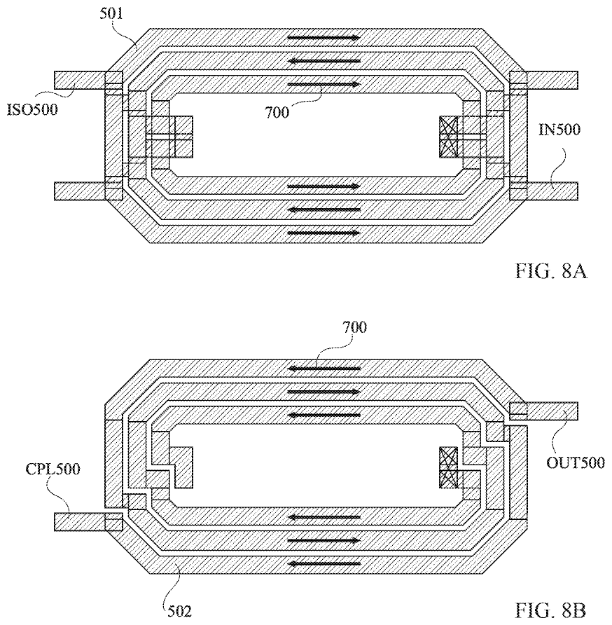

FIGS. 8A and 8B comprise two views showing top views of the metallizations 501 and 502 of the coupler 500 described in relation with FIG. 6. According to an embodiment, FIG. 8A illustrates metallization 501, and FIG. 8B illustrates metallization 502.

Arrows 700 are used to indicate the direction of the signal transmitted by the metallizations.

It should be noted that the directions of the currents flowing through the metallization portions arranged in the first metallization level are always opposite to the directions of the currents flowing through the metallization portions arranged in the second metallization level arranged directly underneath, which specific point enables to implement the additional coupling, which is the advantage of these embodiments.

FIGS. 9A, 9B, and 9C comprises three graphs illustrating the performance of the coupler 500 described in relation with FIG. 6.

The graph in FIG. 9A comprises two curves 801 and 802. Curves 801 and 802 are frequency diagrams representing the impedances simulated across the coupler. This graph is known to those skilled in the art as the Smith chart

The graph in FIG. 9B comprises four curves 803, 804, 805, and 806. Curves 803 to 806 show the variation of the performance of coupler 500 versus frequency. Curves 803 and 805 show the losses on each of the coupler outputs as compared with the input signal. A marker indicates the frequency at which exactly the same amount of signal is present on each of the outputs. Curves 804 and 806 show the matching of the input signals of the coupler.

The graph in FIG. 9C comprises two curves 807 and 808. Curves 807 and 808 show the performance of coupler 500 versus frequency. Curve 808 shows the phase difference between the two coupler output signals versus frequency, and curve 807 shows the amplitude difference between the two coupler output signals versus frequency. The zero crossing of curve 807 indicates the frequency at which the same amount of signal is obtained at both coupler outputs.

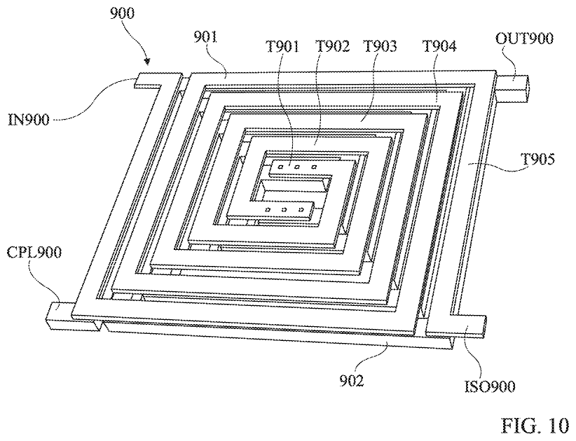

FIG. 10 is a perspective view of an embodiment of a coupler 900 being a variant of the coupler 400 of FIGS. 4A, 4B, 4C, and 4D and of the coupler 500 of FIG. 6.

Coupler 900 is particularly similar to coupler 500. The elements common to devices 500 and 900 are not described again in detail hereafter. The differences between couplers 500 and 900 are highlighted.

More particularly, like coupler 500, coupler 900 comprises two input terminals IN900 and CPL900 and two output terminals OUT900 and ISO900. In addition, like coupler 500, coupler 900 is formed from two metallizations 901 and 902.

The difference between couplers 500 and 900 is that the metallizations of coupler 900 are arranged in spirals and comprise at least five turns which are more strongly concentrated at the center. In addition, the shape of coupler 900 is substantially that of a square, or is inscribed within a square shape. The latter can be rounded, elliptical or any other shape corresponding to a specific application.

More specifically, in the example of FIG. 10, the metallizations of coupler 900 are arranged in spirals and comprise five turns T901, T902, T903, T904, and T905. The spacing between these turns is not subject to a minimum distance.

A specific advantage of these embodiments is that the negative coupling present on the central portion of the spiral is compensated for by all the other positive couplings present between the two metallization levels.

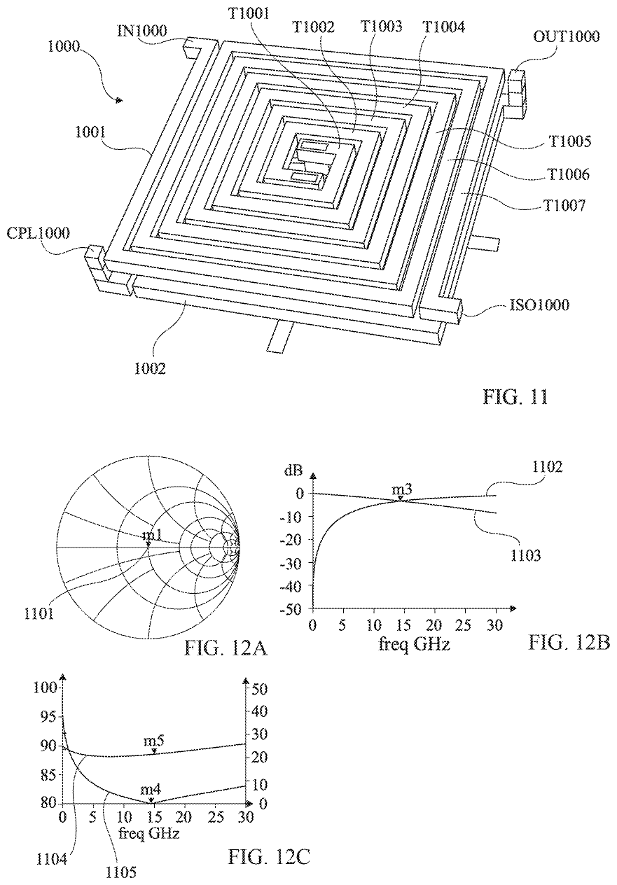

FIG. 11 is a perspective view of an embodiment of a coupler 1000 being a variant of the coupler 400 of FIGS. 4A, 4B, 4C, and 4D, of the coupler 500 of FIG. 6, and of the coupler 900 of FIG. 10.

Coupler 1000 is particularly similar to coupler 900. The elements common to devices 900 and 1000 are not described again in detail hereafter. The differences between couplers 900 and 1000 are highlighted.

More particularly, like coupler 900, coupler 1000 comprises two input terminals IN1000 and CPL1000 and two output terminals OUT1000 and ISO1000. In addition, like coupler 900, coupler 1000 is formed from two metallizations 1001 and 1002.

The difference between couplers 900 and 1000 is that the metallizations of coupler 1000 are arranged in spirals and comprise at least seven turns. In addition, the shape of coupler 1000 is substantially that of a square or is inscribed within a square shape.

In addition, according to an example, it is possible to form the couplers with metallization levels of different thicknesses and/or of different materials. More generally, the two metallization levels of the coupler can be manufactured by using different manufacturing methods and therefore different technologies.

More particularly, in the example of FIG. 11, the metallizations of coupler 1000 are arranged in spirals and comprise seven turns T1001 to T1007. The spacing between these turns is not subject to a minimum distance.

FIGS. 12A, 12B, and 12C comprises three graphs illustrating the performance of the coupler 1000 described in relation with FIG. 11.

The graph in FIG. 12A comprises a curve 1101. This curve 1101 is a frequency diagram representing the impedances simulated at the coupler terminals. This graph is known to those skilled in the art as the Smith chart.

The graph in FIG. 12B comprises two curves 1102 and 1103. These curves 1102 and 1103 represent the variation of the performance of coupler 1000 versus frequency for each of the coupler outputs. A marker indicates the frequency for which exactly the same amount of signal is present on each of the outputs.

The graph in FIG. 12C comprises two curves 1104 and 1105. These curves 1104 and 1105 represent the variation of the performance of coupler 1000 versus frequency. Curve 1104 concerns the variation of the phase difference between the signals of the two coupler outputs versus frequency, and curve 1105 shows the amplitude difference between the two coupler output signals versus frequency. The zero crossing of curve 807 indicates the frequency at which the same amount of signal is obtained on the two coupler outputs.

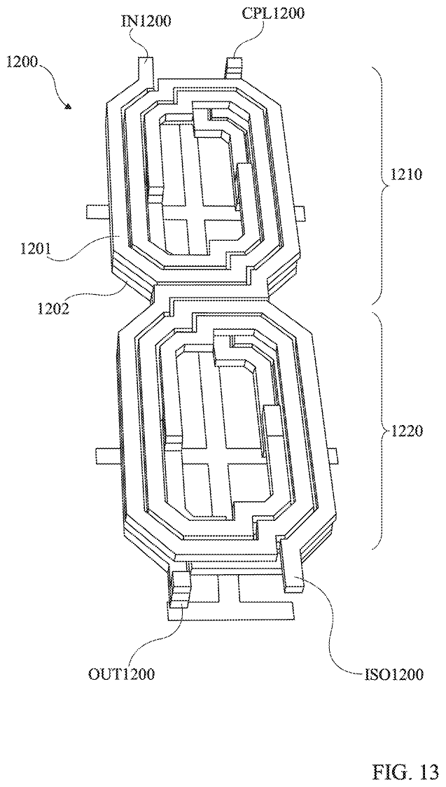

FIG. 13 is a perspective view of an embodiment of a coupler 1200 being a variant of the coupler 400 of FIGS. 4A, 4B, 4C, and 4D, of the coupler 500 of FIG. 6, of the coupler 900 of FIG. 10, and of the coupler 1000 of FIG. 11.

Coupler 1200 is particularly of the type of the coupler 500 described in relation with FIG. 6. The elements common to devices 500 and 1200 are not described again in detail hereafter. The differences between couplers 500 and 1200 are highlighted.

More particularly, like coupler 500, coupler 1200 comprises two input terminals IN1200 and CPL1200 and two output terminals OUT1200 and ISO1200. In addition, like coupler 500, coupler 1200 is formed from two metallizations 1201 and 1202.

According to an embodiment, coupler 1200 corresponds to the assembly of two couplers 1210 and 1220 of the type of the coupler 500 described in relation to FIG. 6. The input terminals of coupler 1210 form the input terminals of coupler 1200, and the output terminals of coupler 1220 form the output terminals of coupler 1200. The output terminals of coupler 1210 are coupled, preferably connected, to the input terminals of coupler 1220.

In other words, coupler 1200 can be seen as an electronic device comprising two couplers 500 described in relation with FIG. 6 coupled in series. An advantage of such an assembly is to adapt the coupler to the device size on an electronic chip. Another advantage is that such an assembly can enable to adapt the frequency of the received signal, for example by decreasing it.

In FIG. 13, the two couplers 1210 and 1220 have been shown as being positioned in the same plane. But it is also possible to consider that couplers 1210 and 1220 are arranged one above the other in planes parallel to each other.

Various embodiments and variants have been described. The person skilled in the art will understand that certain features of these various embodiments and variants could be combined, and other variants will become apparent to the person skilled in the art.

In particular, the two metallization levels forming the couplers according to an embodiment can be separated by other metallization levels comprising no electronic component directly at a coupler metallization.

Finally, the practical implementation of the described embodiments and variants is within the reach of the person skilled in the art on the basis of the functional indications given above.

A coupler (400; 500; 900; 1000; 1200) is summarized as including: a first input terminal (IN400; IN500; IN900; IN1000; IN1200) coupled to a first output terminal (OUT400; OUT500; OUT900; OUT1000; OUT1200) by a first metallization (401; 501; 901; 1001; 1201); and a second input terminal (CPL400; CPL500; CPL900; CPL1000; CPL1200) coupled to a second output terminal (ISO400; ISO500; ISO900; ISO1000; ISO1200) by a second metallization (402; 502; 902; 1002; 1202), wherein each of the first and second metallizations (401, 402; 501, 502; 901, 902; 1001, 1002; 1201, 1202) is divided into a first portion (401a, 402b) arranged in a first metallization level located in a first plane, and a second portion (401b, 402a) arranged in a second metallization level located in a second plane, different from the first plane and parallel to the first plane, wherein each of the first portions (401a, 402b) of metallization (401, 402; 501, 502; 901, 902; 1001, 1002; 1201, 1202) is positioned directly above one of the second portions (401b, 402a) of metallization (401, 402; 501, 502; 901, 902; 1001, 1002; 1201, 1202).

A method is summarized as including coupling two signals using a coupler, the coupler including: a first input terminal (IN400; IN500; IN900; IN1000; IN1200) coupled to a first output terminal (OUT400; OUT500; OUT900; OUT1000; OUT1200) by a first metallization (401; 501; 901; 1001; 1201); and a second input terminal (CPL400; CPL500; CPL900; CPL1000; CPL1200) coupled to a second output terminal (ISO400; ISO500; ISO900; ISO1000; ISO1200) by a second metallization (402; 502; 902; 1002; 1202), wherein each of the first and second metallizations (401, 402; 501, 502; 901, 902; 1001, 1002; 1201, 1202) is divided into a first portion (401a, 402b) arranged in a first metallization level located in a first plane, and a second portion (401b, 402a) arranged in a second metallization level located in a second plane, different from the first plane and parallel to the first plane, wherein each of the first portions (401a, 402b) of metallization (401, 402; 501, 502; 901, 902; 1001, 1002; 1201, 1202) is positioned directly above one of the second portions (401b, 402a) of metallization (401, 402; 501, 502; 901, 902; 1001, 1002; 1201, 1202).

The first portion (401a) of the first metallization (401; 501; 901; 1001; 1201) is arranged directly above the second portion (402a) of the second metallization (402; 502; 902; 1002; 1202).

A first current flowing through the first portion (401a) of the first metallization (401; 501; 901; 1001; 1201) flows in a direction opposite to that of a second current flowing through the second portion (402a) of the second metallization (402; 502; 902; 1002; 1202).

The first portion of the first metallization (401; 501; 901; 1001; 1201) is arranged directly above the second portion of the first metallization (401; 501; 901; 1001; 1201).

A first current flowing through the first portion of the first metallization (401; 501; 901; 1001; 1201) flows in a direction identical to that of a second current flowing through the second portion of the first metallization (401; 501; 901; 1001; 1201).

The first portion (401a) of the first metallization (401; 501; 901; 1001; 1201) and the second portion (401b) of the first metallization (401; 501; 901; 1001; 1201) are coupled together by a first conductive via (403).

The first portion (402a) of the second metallization (402; 502; 902; 1002; 1202) and the second portion (402b) of the second metallization (402; 502; 902; 1002; 1202) are coupled together by a second conductive via (403).

The first metallization (401; 501; 901; 1001; 1201) is generally spiral-shaped,
said second metallization (402; 502; 902; 1002; 1202) is generally spiral-shaped.

The first metallization (501; 901; 1001; 1201) is in the general shape of a spiral including at least three turns,
said second metallization (502; 902; 1002; 1202) is in the general shape of a spiral including at least three turns.

The first metallization (401; 501; 901; 1001; 1201) is in the general shape of a spiral inscribed within a rectangular, square, rounded, or elliptical shape,
said second metallization (402; 502; 902; 1002; 1202) is in the general shape of a spiral inscribed within a rectangular, square, rounded, or elliptical shape.

The first and second metallizations (401, 402; 501, 502; 901, 902; 1001, 1002; 1201, 1202) are arranged so as to leave a gap (450) between their first and second portions.

The coupler is a ninety-degree hybrid coupler.

The coupler is a one-hundred-and-eighty-degree hybrid coupler.

An electronic device is summarized as including at least two couplers discussed above coupled in series with one another.

The at least two couplers are positioned in a same third plane.

The at least two couplers are positioned one above the other in fourth planes parallel to one another.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A coupler comprising:
a first input terminal coupled to a first output terminal by a first metallization; and
a second input terminal coupled to a second output terminal by a second metallization,
wherein each of the first and second metallizations is divided into a first portion arranged in a first metallization level located in a first plane, and a second portion arranged in a second metallization level located in a second plane, different from the first plane and parallel to the first plane,
wherein each of the first portions of the first and second metallizations is positioned directly above one of the second portions of the first and second metallizations.

2. The coupler according to claim 1, wherein the first portion of the first metallization is arranged directly above the second portion of the second metallization.

3. The coupler according to claim 2, wherein, in operation, a first current flowing through the first portion of the first metallization flows in a direction opposite to that of a second current flowing through the second portion of the second metallization.

4. The coupler according to claim 1, wherein the first portion of the first metallization is arranged directly above the second portion of the first metallization.

5. The coupler according to claim 4, wherein, in operation, a first current flowing through the first portion of the first metallization flows in a direction identical to that of a second current flowing through the second portion of the first metallization.

6. The coupler according to claim 1, wherein the first portion of the first metallization and the second portion of the first metallization are coupled together by a conductive via.

7. The coupler according to claim 1, wherein the first portion of the second metallization and the second portion of the second metallization are coupled together by a conductive via.

8. The coupler according to claim 1, wherein
the first metallization is spiral-shaped, and
the second metallization is spiral-shaped.

9. The coupler according to claim 8, wherein
the first metallization is in the shape of a spiral having at least half a turn, and
the second metallization is in the shape of a spiral having at least half a turn.

10. The coupler according to claim 8, wherein
the first metallization is in the shape of a spiral inscribed within a rectangular, square, rounded, or elliptical shape, and
the second metallization is in the shape of a spiral inscribed within a rectangular, square, rounded, or elliptical shape.

11. The coupler according to claim 1, wherein the first and second metallizations are arranged so as to leave a gap between their first and second portions.

12. The coupler according to claim 1, wherein the coupler is a ninety-degree hybrid coupler.

13. The coupler according to claim 1, wherein the coupler is a one-hundred-and-eighty-degree hybrid coupler.

14. An electronic device comprising:
at least two couplers coupled in series with one another, each of the at least two couplers including:
a first input terminal coupled to a first output terminal by a first metallization; and
a second input terminal coupled to a second output terminal by a second metallization,
wherein each of the first and second metallizations is divided into a first portion arranged in a first metallization level located in a first plane, and a second portion arranged in a second metallization level located in a second plane, different from the first plane and parallel to the first plane,
wherein each of the first portions of the first and second metallizations is positioned directly above one of the second portions of the first and second metallizations.

15. The electronic device according to claim 14, wherein the at least two couplers are positioned in a same third plane.

16. The electronic device according to claim 14, wherein the at least two couplers are positioned one above the other in third planes parallel to one another.

17. The electronic device according to claim 14, wherein the first portion of the first metallization is arranged directly above the second portion of the second metallization.

18. The electronic device according to claim 14, wherein the first portion of the first metallization is arranged directly above the second portion of the first metallization.

19. A method comprising:
coupling two signals using a coupler, the coupler including:
a first input terminal coupled to a first output terminal by a first metallization; and
a second input terminal coupled to a second output terminal by a second metallization,
wherein each of the first and second metallizations is divided into a first portion arranged in a first metallization level located in a first plane, and a second portion arranged in a second metallization level located in a second plane, different from the first plane and parallel to the first plane,
wherein each of the first portions of the first and second metallizations is positioned directly above one of the second portions of the first and second metallizations.

20. The method according to claim 19, wherein the first portion of the first metallization is arranged directly above the second portion of the first metallization.
